(19) United States
(12) Patent Application Publication
(10) Pub. No.: US 2005/0279974 A1
(43) Pub. Date: Dec. 22, 2005

(54) Dampening device for high lift jacks

(76) Inventor: Michael K. Schwitzing, Mobile, AL (US)

Correspondence Address: ELLIS & VENABLE, PC, 101 NORTH FIRST AVE., SUITE 1875, PHOENIX, AZ, 85003, US

(21) Appl. No.: 10/799,294

(22) Filed: Mar. 12, 2004

Related U.S. Application Data
(60) Provisional application No. 60/463,400, filed on Apr. 17, 2003.

(51) Int. Cl. B66F 1/04

(52) U.S. Cl. 254/108

(57) ABSTRACT

The invention is summarized as dampening device for high lift jacks. The dampener is a one-piece flexible member having two shafts: the first shaft for the I-beam of the high lift jack and the second shaft for the jack handle. The dampener slides over the I-beam and the jack handle respectively to snugly secure the jack handle to the I-beam. The dampener prevents the jack handle of a high lift jack from swinging and rattling against the I-beam when the high lift jack is not in use. The dampener can also be quickly and easily removed from the jack handle when the high lift jack is needed for use.

### CROSS-REFERENCE TO RELATED APPLICATIONS

The present application claims priority to copending US provisional application entitled “Handle Hugger,” having Ser. No. 60/463,400 filed by inventor Michael K. Schwitzing on Apr. 17, 2003, which is entirely incorporated herein by reference.

### FIELD OF THE INVENTION

The present invention relates to jacks and, more specifically, to dampening devices for high lift jacks.

### BACKGROUND OF THE INVENTION

There are many types of jacks and jacking systems. Some jacks employ a vertically oriented I-beam upon which the jack climbs when the jack handle is activated. These jacks are commonly referred to a “high lift jacks” or “farmer's jacks.” A well-known example of a “high lift jack” is sold by Bloomfield Manufacturing Co., Inc. under the trademark HI-LIFT®. Information regarding the HI-LIFT® jack can be found on the website authored by Bloomfield Manufacturing Co., Inc. at www.hi-lift.com.

It can be advantageous to carry a high lift jack in a vehicle, particularly when the vehicle is driven off road. One drawback to carrying a high lift jack in a vehicle is that the jack's handle moves relative to the I-beam. For example, when driving a vehicle with a high lift jack, the jack handle vibrates against the I-beam causing noise and ultimately damaging the high lift jack. This situation is intensified when the vehicle is driven in off-road situations. What is needed is a convenient, economical and effective dampener that can secure a high lift jack without negatively affecting the usability and versatility of the high lift jack.

### SUMMARY OF THE INVENTION

The invention is summarized below only for purposes of introducing embodiments of the invention. The ultimate scope of the invention is to be limited only to the claims that follow the specification.

The invention is summarized as dampening device for high lift jacks. The dampener is a one-piece flexible member having two shafts: the first shaft for the I-beam of the high lift jack and the second shaft for the jack handle. The dampener slides over the I-beam and the jack handle respectively to snugly secure the jack handle to the I-beam. The dampener prevents the jack handle of a high lift jack from swinging and rattling against the I-beam when the high lift jack is not in use. The dampener can also be quickly and easily removed from the jack handle when the high lift jack is needed for use.

### BRIEF DESCRIPTION OF THE DRAWINGS

FIG. 1 illustrates a perspective view of the preferred embodiment of the dampener in use with a high lift jack.

FIG. 2A illustrates a top view of the preferred embodiment of the dampener.

FIG. 2B illustrates a side view of the preferred embodiment of the dampener.

FIG. 3 a perspective view of the preferred embodiment of the dampener.

### DESCRIPTION

The description that follows is intended to aid in the understanding but not limit the actual scope of the invention. It is to be understood that the description below is merely illustrative of the presently preferred embodiments of the invention and that no limitations are intended to the detail of construction or design herein shown other than as defined in the appended claims.

As used herein, “high lift jack” refers to any jack that employs a vertically oriented I-beam 6 upon which the jack climbs when the jack handle 8 is activated. A popular example of a high lift jack is sold by Bloomfield Manufacturing Co., Inc. under the trademark HI-LIFT®. Information regarding the HI-LIFT® jack can be found on the website authored by Bloomfield Manufacturing Co., Inc. at www.hi-lift.com.

Broadly, the dampening device comprises a one-piece flexible member 10, wherein the one-piece flexible member 10 has a first shaft 12 and a second shaft 14. The first shaft 12 and the second shaft 14 are substantially parallel to each other and both fully penetrate the one-piece flexible member 10. It is preferred that the cross section of the first shaft 12 be substantially the same shape as the cross section of the I-beam 6 of the high lift jack. It is preferred that the cross section of the second shaft 14 be substantially the same shape as the cross section of the jack handle 8 of the high lift jack.

It is preferred that the size of the first and second shaft 12, 14 be slightly smaller than the cross section of the I-beam 6 and jack handle 8 to achieve a snug fit. For example it is preferred that the diameter of the first shaft 12 be 1.33 inches for use with the HI-LIFT® jack. Similarly, it is preferred that the second shaft 14 have a length of 1.95 inches, a flange thickness of 0.60 inches, a flange width of 0.88 inches and a web thickness of 0.38 inches for use with the HI-LIFT® jack. Other sizes can be adapted to fit other jacks. It is preferred that the one-piece flexible member 10 be 4.63 inches long, 1 inch thick and have a minimum of 0.25 inches between the edge of the one-piece flexible member 10 and the edge of the first or second shafts 12, 14.

Many flexible yet resilient materials can be used for the one-piece member. It is preferred to use urethane but other materials known in the art such as polyurethane, ethylene propylene dieneter polymer (or “EDPM”), rubber, closed cell foam, composite blends, or plastic could also be used. It is preferred to manufacture the one-piece member using an injection mold process. Other methods of manufacture known in the art can also work, including cnc water jet cutting and cast molding.

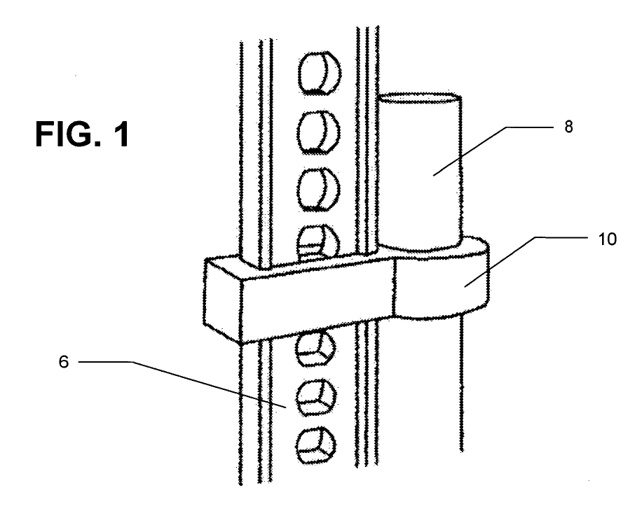

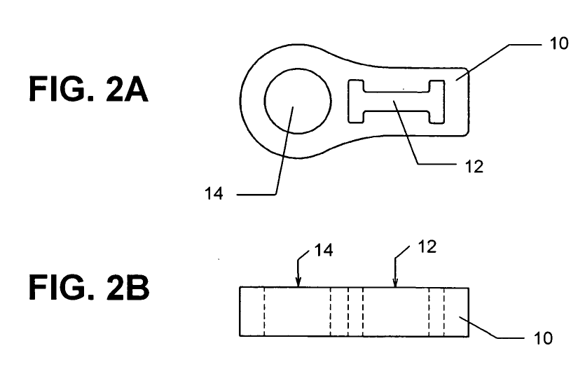

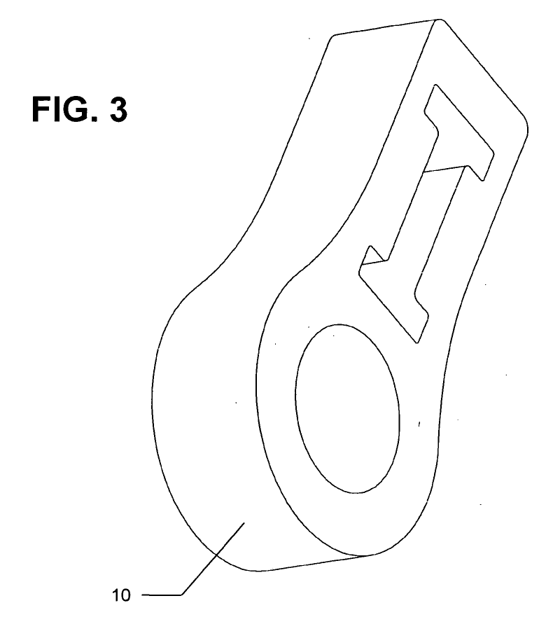

To use the dampening device, one would slide the first shaft 12 onto the I-beam 6 and slide it down to a point approximately even with the end of the jack handle 8 when the jack handle 8 is rotated so that it is substantially parallel to the I-beam 6. The user would then slide the second shaft over the jack handle 8 as shown in FIG. 1. To use the jack, the user would slip the one-piece flexible member 10 off the jack handle 8 and use the jack with the one-piece flexible member 10 still on the I-beam 6. The user would only need to slide the one-piece flexible member 10 along the I-beam 6 if necessary. When the user is finished using the jack, the user could again rotate the jack handle 8 so that it was substantially parallel to the I-beam 6 and slide the second shaft over the jack handle 8 as shown in FIG. 1.

Although the invention has been described in detail with reference to one or more particular preferred embodiments, persons possessing ordinary skill in the art to which this invention pertains will appreciate that various modifications and enhancements may be made without departing from the spirit and scope of the claims that follow.

1. A dampener for a high lift jack comprising a one-piece flexible member, a first shaft and a second shaft, wherein the first shaft and the second shaft are substantially parallel to each other and both fully penetrate the one-piece flexible member, the cross section of the first shaft is substantially the same shape as the cross section of an I-beam of a high lift jack, the cross section of the second shaft is substantially the same shape as the cross section of a jack handle of the high lift jack.

2. The dampener of claim 1 wherein the one-piece flexible member is made from a material selected from the group consisting of urethane, polyurethane, ethylene propylene dieneter polymer, EDPM, rubber, closed cell foam, composite blends, and plastic.

3. The dampener of claim 1 wherein the one-piece flexible member is made from urethane.

4. The dampener of claim 1 wherein the size of the first and second shaft are smaller than the cross section of the I-beam and jack handle.

5. The dampener of claim 1 wherein the diameter of the second shaft is 1.33 inches.

6. The dampener of claim 1 wherein the first shaft has a length of 1.95 inches, a flange thickness of 0.60 inches, a flange width of 0.88 inches and a web thickness of 0.38 inches.

7. The dampener of claim 1 wherein the one-piece flexible member is 1 inch thick.

8. The dampener of claim 1 wherein the minimum thickness between the edge of the one-piece flexible member and the edge of the first or second shafts is 0.25 inches.
